(19) United States
(12) Patent Application Publication
(10) Pub. No.: US 2008/0079599 A1
(43) Pub. Date: Apr. 3, 2008

(54) Detector with voice output

(76) Inventor: Rajiv Partha Sarathy, Bellevue, WA (US)

Correspondence Address: Rajiv Sarathy;Suite 4800, 1201, Third Avenue, Seattle, WA, 98101, US

(21) Appl. No.: 11/542,467

(22) Filed: Oct. 2, 2006

(51) Int. Cl. G08B 25/08; G08B 17/10

(52) U.S. Cl. 340/692; 340/628; 340/632

(57) ABSTRACT

A detector with voice output is described. In various embodiments, the detector comprises a detection circuit that detects a substance, a recording circuit that records a sound in a memory, and a playback circuit that retrieves the recorded sound from memory and emits the recorded sound via a speaker when the detection circuit detects the substance. The recorded sound can be a human voice.

### BACKGROUND

Detectors conventionally emit a loud, audible alarm or a visual alarm when they detect a substance. Examples of commonly employed detectors are carbon monoxide detectors and smoke detectors. When these devices detect carbon monoxide or smoke, they emit an alarm. They may also summon help, such as by notifying a remote operator.

Fire marshals recommend placing such detectors near bedrooms so that occupants can be awoken when the detector detects substances it is designed to detect. In some homes, smoke detectors are placed within each bedroom so that occupants of the bedroom can be quickly alerted.

It is conventional wisdom that time is of paramount importance in successfully escaping a noxious substance, such as carbon monoxide and smoke. A few minutes can make the difference between life and death. It is possible that some individuals react more quickly to human voices or other noises than alarm sounds, such as monotonic alarm sounds. As an example, children who are in deep sleep can awaken more quickly to a command from their mother than from a monotonic alarm.

### BRIEF DESCRIPTION OF THE DRAWINGS

FIGS. 1A and 1B are partially isometric views of a detector in accordance with an embodiment of a detector.

FIG. 2 is a block diagram illustrating an embodiment of a detector.

FIG. 3-4 are flow diagrams illustrating routines performed by a detector in various embodiments.

### DETAILED DESCRIPTION

A detector with voice output is described. In various embodiments, the detector includes a recording circuit and a playback circuit. When the detector detects a substance that the detector is designed to detect, it can cause a voice to be played. As an example, when a detector detects smoke, it can cause a mother's voice to be emitted that indicates to a child to wake up. The detector may include a voice capture circuit that a user can employ to record a voice. As an example, the mother may have previously recorded the voice using the voice capture circuit. The voice capture circuit can be employed to record sounds (e.g., a voice) by depressing a record button. After speaking the voice or otherwise capturing sound, such as by placing the sound close to a microphone, voice capture can be ended, such as by stopping to depress the record button.

The detector can have a test button, such as to playback the recorded voice. When the test button is momentarily depressed, the detector may play back the previously recorded sound.

The voice capture and playback circuits can be employed to record and playback various sounds. As an example, the detector may be employed to record and playback various sounds rather than voices or alarms.

The detector may have a microphone suitable for capturing sounds (e.g., voices). The detector may have a speaker suitable for playing captured sounds. The speaker may be capable of playing sounds at high decibels, e.g., sufficient to wake someone up.

In various embodiments, either or both of the playback and recording circuits can be provided by remote apparatuses that are connected to the detector. As an example, a user may employ another device (e.g., recording device, computing device, and so forth) to capture sounds or a voice in an audio file and then transfer the audio file to the detector. As an example, the detector may connect to a network (e.g., a wireless or wired network) or to a computing device or recording device to receive the audio file.

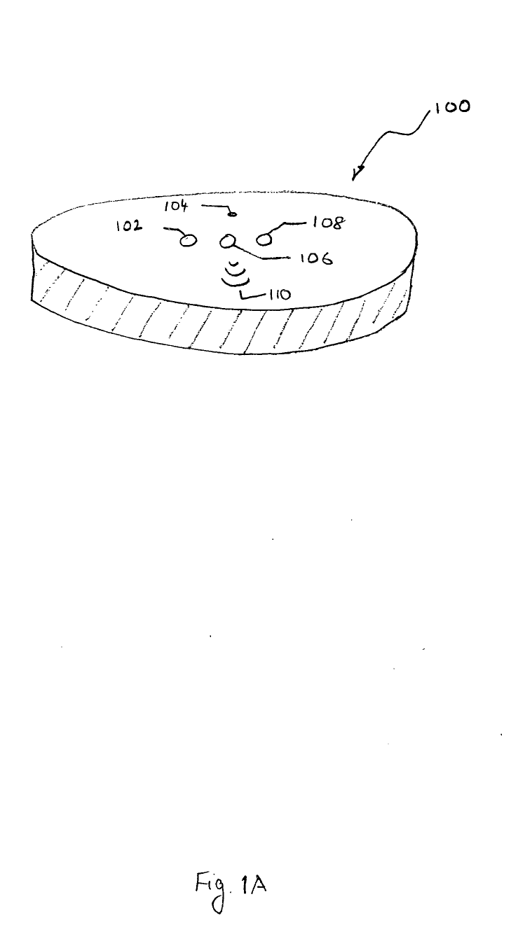

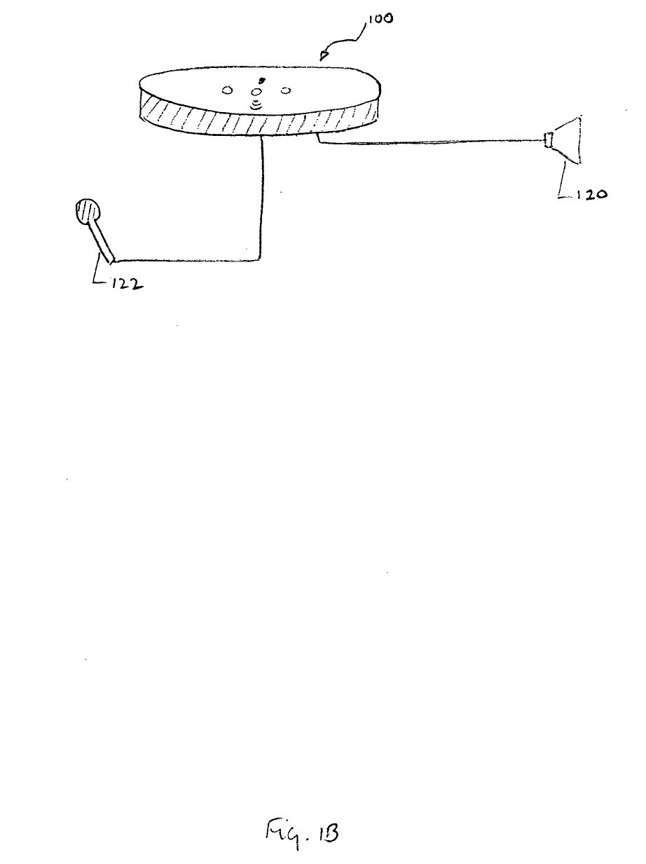

FIGS. 1A and 1B are partially isometric views of a detector in accordance with an embodiment of a detector. A detector 100 illustrated in FIG. 1A comprises a record button 102 and a microphone aperture 104. When the record button 102 is depressed, a recording circuit is enabled for recording sounds captured by a microphone. When the record button is no longer depressed, the recording circuit stops recording. Recorded sounds are stored in a memory.

When a test button 106 is momentarily depressed, a playback circuit retrieves the sounds recorded in the memory and plays back the recorded sounds via a speaker 110.

A lamp 108 may indicate whether a power source (e.g., battery) made available to the detector is operational (e.g., carries a charge).

In various embodiments, the circuits can be located within a housing associated within the detector. Some circuits may be capable of being retrofitted into existing detector designs.

FIG. 1B illustrates a similar detector 100. The detector can optionally be connected to external microphone or speaker sources. As an example, the detector can be connected to a remote speaker 120. When the detector detects a substance it is designed to detect, the detector may cause the recorded sounds to be played back through the external speaker.

The detector can be connected to a remote sound source 122. As examples, the detector can be connected to an external microphone, computing device, recording device, or other source for audio, such as via a wired or wireless connection. The external source may also provide a signal for the detector to begin or stop recording sounds.

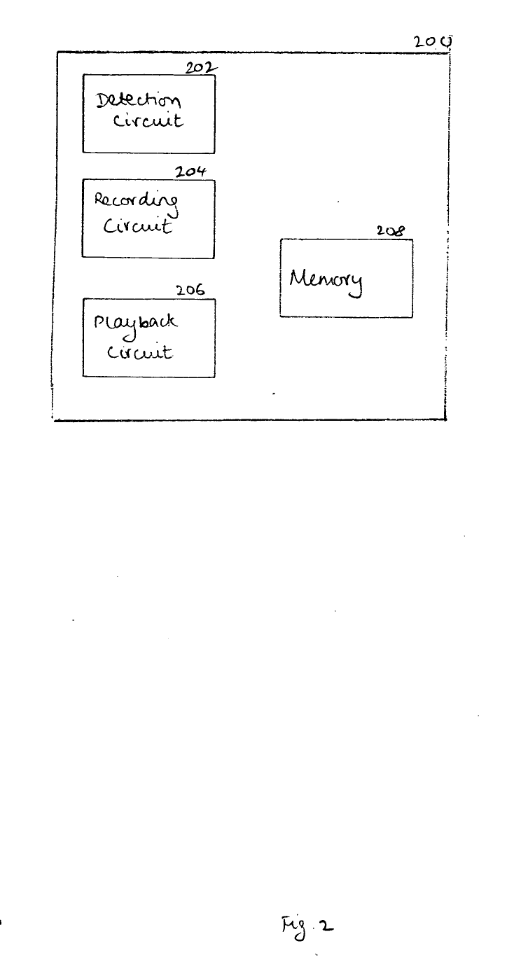

FIG. 2 is a block diagram illustrating an embodiment of a detector. The detector 200 includes a detection circuit 202, recording circuit 204, playback circuit 206, and memory 208.

When the detection circuit detects a substance (e.g., carbon monoxide, smoke, etc.), it causes a signal to be sent to the playback circuit. The playback circuit can retrieve a previously recorded sound from the memory 208 and play the retrieved sound via a speaker.

The recording circuit 204 can be enabled to store sounds into memory 208. As examples, the recording circuit can capture sounds from a microphone or receive sounds from another device, and store these sounds in the memory so that the recording circuit can employ the stored sounds.

The memory can be a solid state memory that is capable of storing data that can be updated, deleted, and so forth. As an example, the memory can be “flash memory,” such as the memory used with universal serial bus (USB) flash drives.

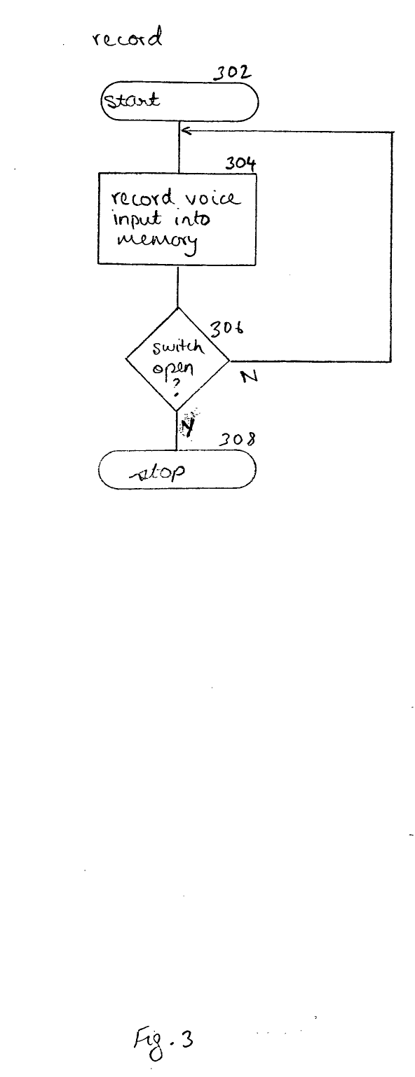

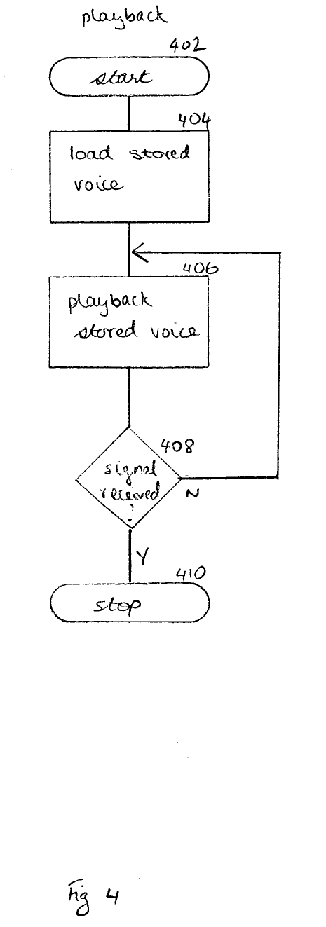

FIG. 3-4 are flow diagrams illustrating routines performed by a detector in various embodiments.

FIG. 3 is a flow diagram illustrating a record routine performed by the detector in some embodiments. The routine begins at block 302. The routine may start when it receives a signal from a user or another device to begin recording. As an example, the routine may start when the user depresses a record button.

At block 304, the routine records sounds (e.g., a voice) into memory.

At block 306, the routine determines whether to continue recording. As an example, if the recording circuit remains closed by the record switch, the routine continues recording at block 304. Otherwise, such as if the record switch is opened (e.g., because it is no longer depressed), the routine continues at block 308, where it stops.

FIG. 4 is a flow diagram illustrating a playback routine performed by the detector in some embodiments. The routine begins at block 302. The routine may start when it receives a signal begin playing back. As an example, the routine may start when the user depresses a test button or when the detector detects a substance it is designed to detect.

At block 404, the routine loads sounds (e.g., a voice) that is stored in memory. In various embodiments, the routine may be capable of playing back stored sounds without first retrieving it.

At block 406, the routine plays back the stored sounds, such as via a speaker connected to the detector. The sounds may be played back loudly, such as to awaken a sleeping person. In some embodiments, the volume of the sounds may be controllable by a user.

At block 408, the routine determines whether to continue playing back. As an example, if the routine receives a signal to stop playing back, the routine continues at block 410, where it returns. Otherwise, the routine continues at block 406, where it sound playback continues. As an example, the routine may play back the recorded voice continuously in a loop until someone or something indicates to the detector to stop playing back the sounds.

In some embodiments, the playback of the recorded sound may include playing back an alarm tone. As an example, the detector may play back the recorded sounds and the alarm tone in alternating or random order.

From the foregoing, it will be appreciated that specific embodiments of the invention have been described herein for purposes of illustration, but that various modifications may be made without deviating from the spirit and scope of the invention. As an example, the detector can detect any type of substance, such as bomb making materials, noxious gases, petroleum byproducts, etc. Any sort of sound capturing and playback mechanism can be used, and any variety of memory can be used. Accordingly, the invention is not limited except as by the appended claims.

I claim:

1. A detection apparatus, comprising:
a detection circuit that detects a substance;
a recording circuit that records a sound in a memory; and
a playback circuit that retrieves the recorded sound from memory and emits the recorded sound via a speaker when the detection circuit detects the substance.

2. The detection apparatus of claim 1 wherein the substance is smoke.

3. The detection apparatus of claim 1 wherein the substance is carbon monoxide.

4. The detection apparatus of claim 1 wherein the recording circuit includes a microphone connected thereto.

5. The detection apparatus of claim 1 wherein the recorded sound is played in addition to an alarm tone.

6. The detection apparatus of claim 1 further comprising a record switch that, when configured to close the recording circuit, causes the recording circuit to record the sound.

7. The detection apparatus of claim 1 wherein the recording circuit is connected to a microphone wherein both the recording circuit and microphone are housed within a housing associated with the detector.

8. The detection apparatus of claim 1 wherein the recording circuit receives a sound recorded by a remote device.

9. The detection apparatus of claim 8 wherein the remote device is a computing device.

10. The detection apparatus of claim 8 wherein the remote device is a remote microphone.

11. The detection apparatus of claim 1 wherein the recording circuit is located within a housing associated with the detector.

12. A method performed by a detector for emitting a recorded sound, comprising:
recording a sound in a memory associated with the detector;
determining whether a substance is detected; and
when the substance is detected, causing the recorded sound to be emitted.

13. The method of claim 12 further comprising retrieving the recorded sound from the memory.

14. The method of claim 12 further comprising retrieving the recorded sound from the memory.

15. The method of claim 12 wherein the sound is a human voice.

16. The method of claim 12 wherein the determining includes sending a signal when the substance is detected.

17. The method of claim 12 further comprising retrofitting the detector with a memory.

18. The method of claim 12 further comprising retrofitting the detector with a playback circuit.

19. A detector apparatus, comprising:
means for detecting a substance;
means for recording a sound in a memory; and
means for retrieving and playing back the recorded sound when the substance is detected.

20. The detector apparatus of claim 19 wherein the means for retrieving and playing back the recorded sound is housed within a housing associated with the detector.
